(19) United States
(12) Patent Application Publication
(10) Pub. No.: US 2010/0085845 A1
(43) Pub. Date: Apr. 8, 2010

(54) INTERCHANGEABLE COVER ASSEMBLY FOR A DEVICE

(75) Inventors: Michael E. OLSEN, Frisco, TX (US); Matthew WEISS, Highland Village, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(73) Assignee: Craftmade International Inc., Coppell, TX (US)

(21) Appl. No.: 12/245,102

(22) Filed: Oct. 3, 2008

(51) Int. Cl. G04B 37/00

(52) U.S. Cl. 368/309

(57) ABSTRACT

An interchangeable cover assembly, comprising an interchangeable cover, a display unit insertable into the interchangeable cover, and at least one retention assembly configured to apply a pressure against the interchangeable cover to secure the display unit to the interchangeable cover.

### BACKGROUND

Users typically purchase devices which match the decor of the room or area which they intend to display, hang, or mount the devices. In some instances, the device no longer matches the decor of the room/area if the furniture, design, and/or color of the room is changed and/or the device is moved to another room/area. Consequently, users typically need to buy a new, different device to match the new decor of the particular room/area.

### BRIEF DESCRIPTION OF THE DRAWINGS

FIGS. 1A and 1B illustrates an embodiment of an interchangeable cover assembly;

FIG. 2 is an assembly view of a retention assembly of the interchangeable cover assembly as illustrated in FIGS. 1A and 1B; and

FIG. 3 is a cross-sectional view of the retention assembly taken along line 3-3 of FIG. 1B.

### DETAILED DESCRIPTION OF THE DRAWINGS

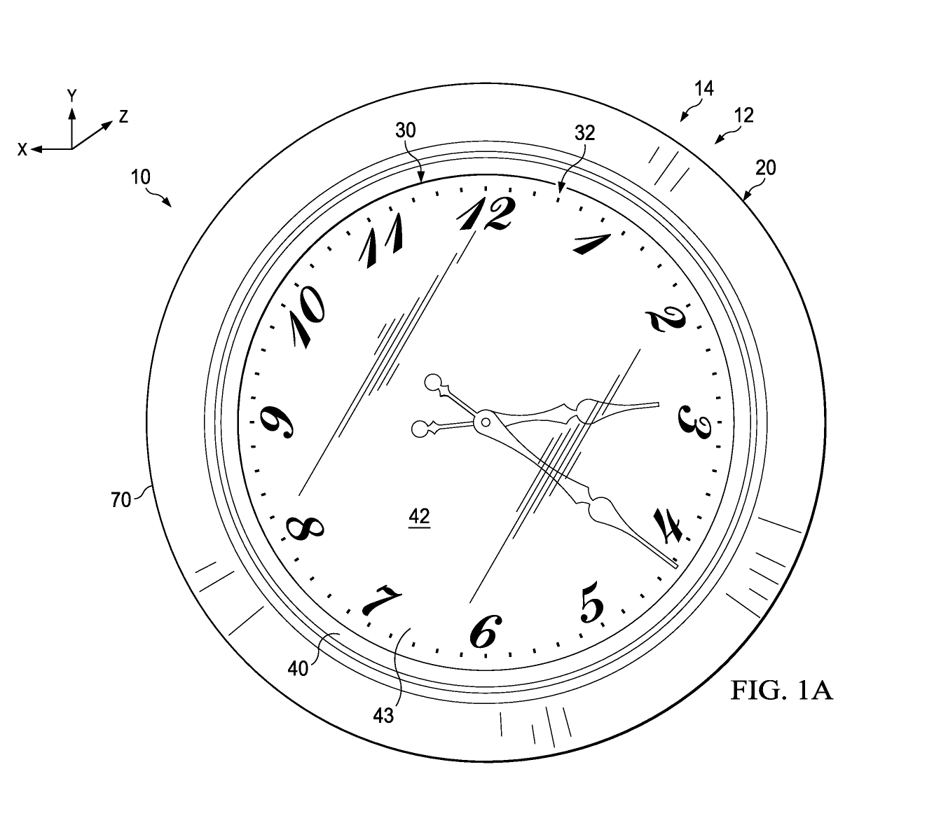

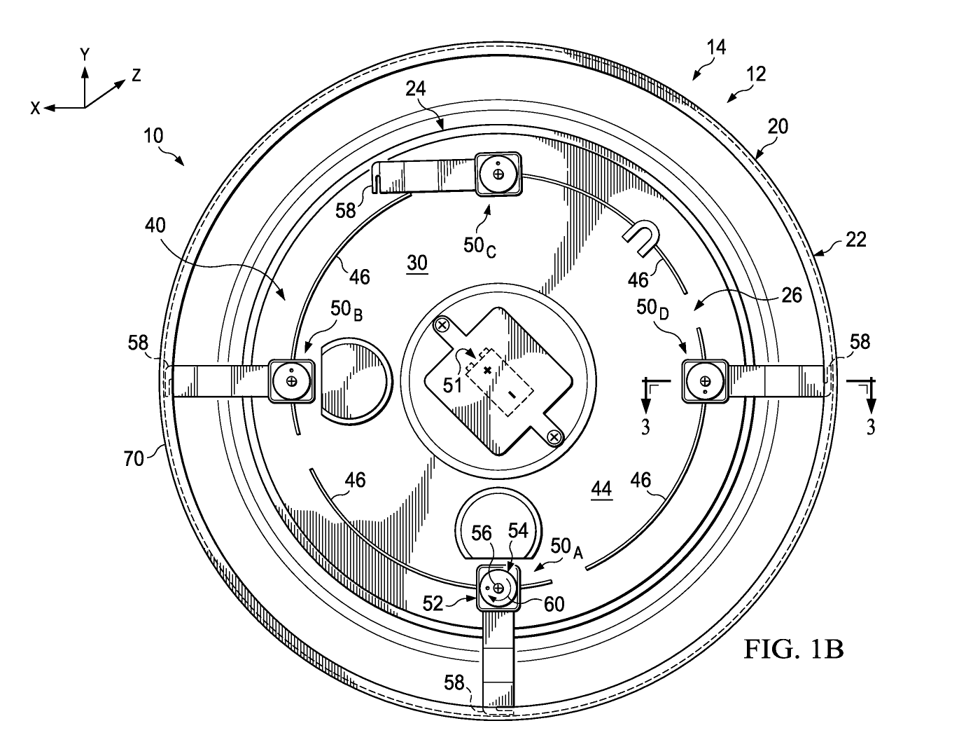

FIGS. 1A and 1B illustrate front and rear views, respectfully, of an interchangeable cover assembly 10 used in connection with a device 12. In the illustrated embodiments, device 12 is illustrated as a clock device 14; however, it should be understood that device 12 may be any other device (e.g., a weather gauge, a barometric pressure device, a photo unit, etc.). In FIGS. 1A and 1B, device 12 comprises an interchangeable cover assembly 10 and a display unit 30. Display unit 30 is any apparatus/device configured to be inserted within interchangeable cover assembly 10 to be presented and/or viewed by a user. In the illustrated embodiments, display unit 30 is a clock unit 32. Display unit 30 comprises a display housing 40 having a front wall 42 and a back wall 44 configured to house at least a portion of the internal components of display unit 30. Referencing FIG. 1A, in some embodiments, front wall 42 is an outwardly facing, transparent surface configured to enable a clock face 43 to be displayed and/or presented. In this context, an “outwardly facing surface” is a surface viewable when device 12 is hung and/or mounted against another surface (e.g., a wall). In some embodiments, front wall 42 may not comprise a transparent surface but may only comprise clock face 43. In FIG. 1B, back wall 44 is an inwardly facing surface and/or, in this context, a surface which is not visable when device 12 is hung and/or mounted against another surface (e.g., a wall). In some embodiments, back wall 44 comprises an area enabling an independent power source 51 (e.g., a battery, etc.) to be installed.

Interchangeable cover assembly 10 is configured to enable device 12 to be interchangeably coupled to any number of different covers to enable a user to customize device 12 to match the decor of a particular room. In FIGS. 1A and 1B, interchangeable cover assembly 10 comprises interchangeable cover 20 and retention assemblies 50. Interchangeable cover 20 is a cover configured to be interchangeably switched, changed, and/or coupled/decoupled from at least a portion of device 12 (e.g., display unit 30). In the illustrated embodiments, interchangeable cover 20 is configured as an annulas and/or a circular ring; however, it should be understood that interchangeable cover 20 may also be any other shape (e.g., a square, a rectangle, a hexagon, etc.). In some embodiments, interchangeable cover 20 comprises an outer periphery 22 and an inner periphery 24, where outer periphery 22 has a circumference larger than inner periphery 24. In some embodiments, interchangeable cover 20 is sloped such that outer periphery 22 is at a different depth position relative to inner periphery 24. For example, outer periphery 22 may be disposed in a different Z coordinate than inner periphery 24. In the illustrated embodiments, inner periphery 24 forms an aperture 26 configured to receive display unit 30 and configured to enable at least a portion of display unit 30 to be presented through aperture 26.

Referring to FIG. 1B, interchangeable cover assembly 10 comprises a number of retention assemblies 50 disposed along a peripheral boundary of back wall 44. Retention assemblies 50 are configured to apply a pressure against interchangeable cover 20 to secure display unit 30 to interchange cover 20. In the illustrated embodiment, interchangeable cover assembly 10 comprises four retention assemblies 50 (e.g., retention assemblies 50_{A}-50_{D}); however, it should be understood that interchangeable cover assembly 10 may comprise more or fewer retention assemblies 50. In some embodiments, each of retention assemblies 50_{A}-50_{D} comprises a base member 52, a swivel member 54, a fastener 56, and a flange 58. Base member 52 enables each of retention assemblies 50 to be coupled to back wall 54 by a fastener (e.g., fastener 56). Swivel member 54 enables each of retention assemblies 50 to rotate and/or turn about fastener 56 in a rotational direction 60. In FIG. 1B, fastener 56 is a screw; however, it should be understood that fastener 56 may be any other type of fastening mechanism, such as, but not limited to, a bolt, a stud, a pin, and a rivet. In the illustrated embodiment, retention assembly 50_{C} is disengaged from interchangeable cover 20 having been rotated opposite to rotational direction 60 or otherwise in a counter-clockwise direction.

In some embodiments, flange 58 is configured to secure display unit 30 to interchangeable cover 20. Specifically, when retention assembly 50 is engaged to outer periphery 22 of interchangeable cover 20, flange 58 applies a pressure against outer periphery 22, thereby positioning and/or disposing display unit 30 within interchangeable cover 20. In some embodiments, outer periphery 22 comprises a lip 70 configured to secure retention assemblies 50 between inner periphery 20 and outer periphery 22 such that retention assemblies 50 do not slide outside the boundary of outer periphery 22 as flange 58 exerts a pressure against interchangeable cover 20. In the illustrated embodiment, retention assemblies 50_{A}, 50_{B}, and 50_{D} are engaged with interchangeable cover 20 such that flange 58 is disposed beneath and/or under lip 70 relative to back wall 44 of display housing 40. In the illustrated embodiment, flange 58 is substantially J-shaped and configured to compress and/or deflect when engaged to outer periphery 22. It should be understood, however, that flange 58 may be otherwise shaped (e.g., L-shaped, etc.).

In FIG. 1B, back wall 44 also comprises detents 46 disposed between each of retention assemblies 50. Detents 46 are configured to limit the rotational movement of retention assemblies 50. In FIG. 1B, detents 46 limit the counter-clockwise rotation (e.g., movement in direction 60) of retention assemblies 50. However, in some embodiments, detents 46 may be absent, thereby enabling retention assemblies 50 to fully rotate about fastener 56.

Thus, in operation, a user rotates and/or turns each of retention assemblies 50 in direction 60 in order for retention assemblies 50 to engage outer periphery 22 of interchangeable cover 20. As each of retention assemblies 50 rotates, at least a portion of flange 58 contacts and/or engages outer periphery 22 and rotationally slides about outer periphery 22 and under lip 70. As flange 58 rotates about interchangeable cover 20, flange 58 compresses and/or deflects and applies a pressure against interchangeable cover 20, thereby securing display unit 30 to interchangeable cover 20. A user then rotates and/or turns each of retention assemblies 50 in a counter-clockwise direction in order to disengage retention assembly 50 from outer periphery 22, thereby enabling interchangeable cover 20 to be removed relative to clock 20.

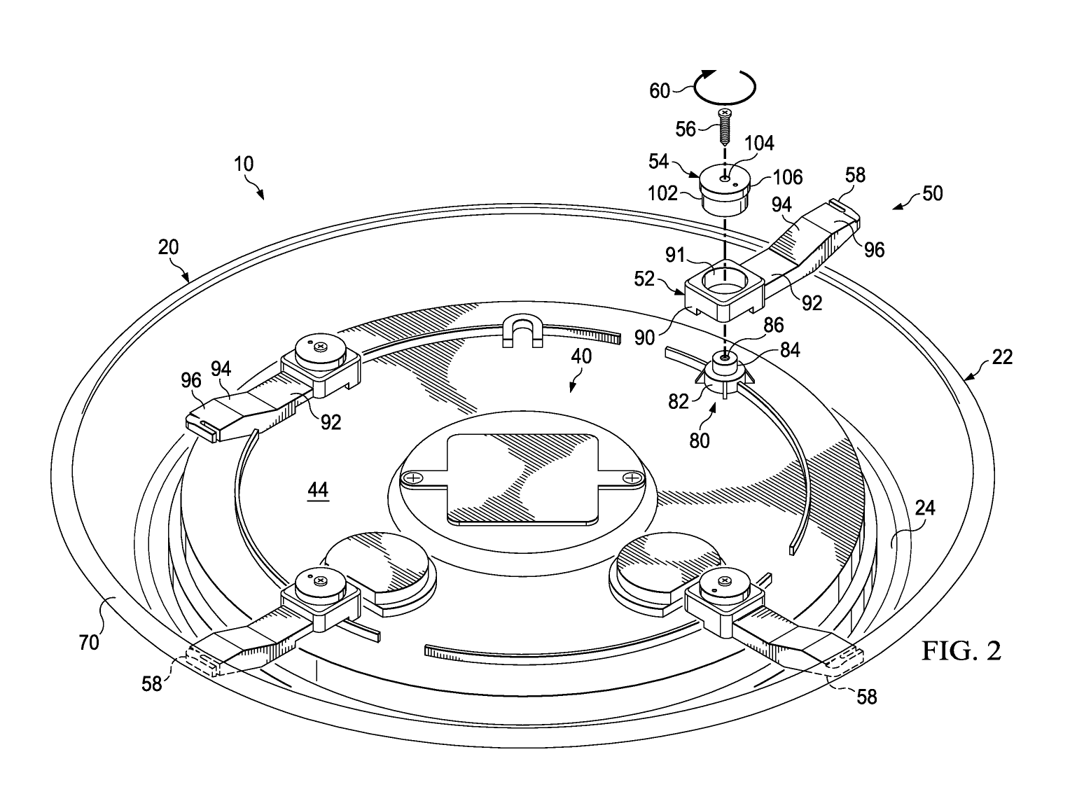

FIG. 2 is an assembly view of a retention assembly 50 for display housing 40 as illustrated in FIGS. 1A and 1B. FIG. 2 illustrates a holding member 80 configured to receive and/or otherwise engage retention assembly 50 so that retention assembly 50 is coupled to back wall 44 of display housing 40. In some embodiments, holding member 80 comprises a base portion 82 and the neck portion 84, wherein base portion 82 has a circumference larger than neck portion 84. In some embodiments, base portion 82 is molded and/or otherwise adhered (e.g., glued, heat staked, soldered, etc.) to back wall 44. In the illustrated embodiment, neck portion 84 comprises an aperture 86 configured to receive and/or engage fastener 56, thereby enabling retention assembly 50 to be coupled to back wall 44.

In the illustrated embodiments, base member 52 of retention assembly 50 comprises an attachment member 90 and a middle portion 92. Attachment member 90 is configured to engage and/or otherwise connect to holding member 80. In FIG. 2, attachment member 90 comprises an aperture 91 having a circumference substantially similar to the circumference of base portion 82 of holding member 80. It should be understood, however, that aperture 91 may be otherwise sized. Aperture 91 is configured to enable at least a portion of swivel member 54 to access and/or couple to neck portion 84 of holding member 80. In FIG. 2, middle portion 92 comprises a two-tiered planar section configured to compress and/or otherwise deflect substantially with flange 58 when flange 58 engages outer periphery 22 of interchangeable cover 20. In some embodiments, middle portion 92 comprises a bend 94 and a bend 96, each of which are configured to flex and/or bend about an axis created by bends 94 and 96 and/or in a direction opposite to the pressure being applied to outer periphery 22. In some embodiments, bends 94 and 96 are configured to ensure that a balanced amount of pressure is being applied to interchangeable cover 20 so that display unit 30 is sufficiently secured (e.g., not too loose or too tight) to interchangeable cover 20. It should be understood, however, that middle portion 92 may be configured with more and/or fewer bends than illustrated.

In FIG. 2, swivel member 54 is substantially T-shaped comprising a neck 102, an aperture 104, and a top portion 106. Neck 102 is configured to engage and/or be inserted into aperture 91 to be coupled to and/or engaged with holding member 80. Aperture 104 is configured to receive a fastener (e.g. fastener 56) to secure and/or connect swivel member 54 to holding member 80. Top portion 106 is sized with a circumference larger than the circumference of aperture 91 so that at least a portion of top portion 106 is disposed above a top side of attachment member 90. Top portion 106 is configured to couple swivel member and base member 52 to holding member 80 while also enabling base member 52 to rotate about neck 102 in a direction 60 so that flange 58 can engage an outer periphery 22 of interchangeable cover 20.

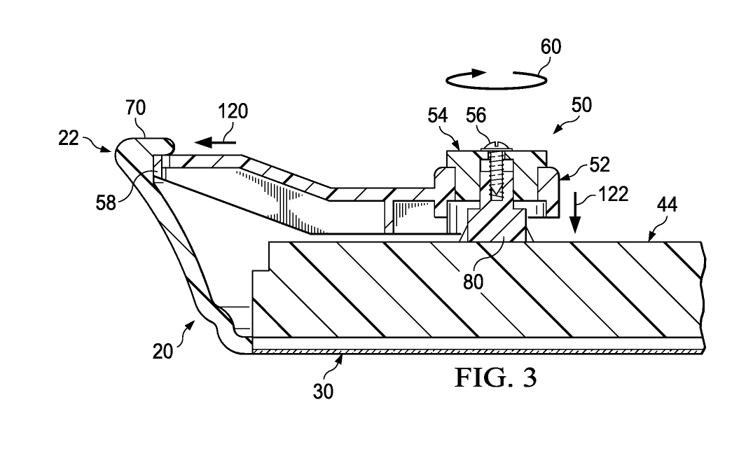

FIG. 3 is a cross-sectional view of a retention assembly 50 taken along line 3-3 of FIG. 1B. In the illustrated embodiment, retention assembly 50 is engaged with interchangeable cover 20 such that retention assembly 50 is applying a pressure against interchangeable cover 20 to secure display unit 30 to interchangeable cover 20. In the illustrated embodiment, fastener 56 secures and/or engages swivel member 54 and base member 52 of retention assembly 50 with holding member 80. Retention assembly 50 is configured to be engaged and/or disengaged from interchangeable cover 20 when rotated respectively in a direction 60 (or otherwise clockwise) or in a direction opposite to direction 60 (or otherwise counter-clockwise).

In some embodiments, outer periphery 22 of display housing 40 comprises a lip 70 configured secure flange 58 and prevent retention assembly 50 from sliding out and/or away from interchangeable cover 20. Thus, lip 70 disposes display unit 30 in a relatively fixed position relative to interchangeable cover 20. Therefore, in operation, when retention assembly 50 is engaged with outer periphery 22, pressures, as illustrated by arrows 120 and 122, are concurrently applied to outer periphery 22 and back wall 44 to secure display unit 30 to interchangeable cover 20.

Embodiments of interchangeable cover assembly 10 may be manufactured by providing interchangeable cover 20, display unit 30, and at least one retention assembly 50 configured to apply a pressure against interchangeable cover 20 to secure display unit 30 to interchangeable cover 20. Interchangeable cover assembly 10 may be further manufactured by providing the at least one retention assembly 50 having a compressible flange 58 configured to deflect and apply pressure against interchangeable cover 20. Interchangeable cover assembly 10 may be further manufactured by providing the at least one retention assembly 50 configured to apply a pressure against an outer periphery 22 of interchangeable cover 20. Interchangeable cover assembly 10 may be further manufactured by rotatably fastening at least one retention assembly 50 to display housing 40 of display unit 30. The method of manufacturing may further provide inserting swivel member 54 into base member 52, swivel member 54 enabling base member 52 to rotate relative to display housing 40. The method of manufacturing may also further provide interchangeable cover 20 having lip 70 configured to prevent at least one retention assembly 50 from slipping outside interchangeable cover 20.

Therefore, embodiments of interchangeable cover assembly 10 enable a user to easily customize display unit 30 by enabling the user to switch out interchangeable cover 20. Interchangeable cover assembly 10 provides at least one retention assembly 50 rotatably configured to easily secure and disengage display unit 30 from interchangeable cover 20. Furthermore, retention assembly 50 is coupled to a back wall 44 of housing 40 and configured to apply a pressure to interchangeable cover 20 to secure display unit 30 to interchangeable cover 20. This feature enables the user to secure display unit 30 to interchangeable cover 20 without using any additional, detachable external components.

What is claimed is:

1. An interchangeable cover assembly, comprising:
an interchangeable cover;
a display unit insertable into the interchangeable cover; and
at least one retention assembly configured to apply a pressure against the interchangeable cover to secure the display unit to the interchangeable cover.

2. The interchangeable cover assembly of claim 1, wherein the at least one retention assembly comprises a compressible flange configured to deflect and apply pressure against the interchangeable cover.

3. The interchangeable cover assembly of claim 1, wherein each of the at least one retention assembly is configured to apply a pressure against an outer periphery of the interchangeable cover.

4. The interchangeable cover assembly of claim 1, wherein the at least one retention assembly is rotatably fastened to a display housing.

5. The interchangeable cover assembly of claim 1, wherein the at least one retention assembly is configured to rotatably secure and disengage the display unit relative to the interchangeable cover.

6. The interchangeable cover assembly of claim 1, wherein each of the at least one retention assembly comprises a fastener insertable into a base member, the fastener securing the at least one retention assembly to a housing for the display unit.

7. The interchangeable cover assembly of claim 1, wherein the at least one retention assembly comprises a swivel member insertable into a base member, the swivel member enabling the base member to rotate relative to the display unit.

8. The interchangeable cover assembly of claim 1, wherein the at least one retention assembly is disposed along a back wall of a display housing.

9. The interchangeable cover assembly of claim 1, wherein the at least one retention assembly is disposed along the periphery of the back wall of a display housing.

10. The interchangeable cover assembly of claim 1, wherein the interchangeable cover comprises a lip configured to secure the display unit in a fixed position relative to the interchangeable cover.

11. The interchangeable cover assembly of claim 1, wherein the interchangeable cover comprises a lip configured to prevent the at least one retention assembly from slipping outside the interchangeable cover.

12. A method of manufacturing an interchangeable cover assembly, the method comprising:
providing an interchangeable cover;
providing a display unit insertable into the interchangeable cover and providing at least one retention assembly configured to apply a pressure against the interchangeable cover to secure the display unit to the interchangeable cover.

13. The method of claim 12, further comprising providing the at least one retention assembly having a compressible flange configured to deflect and apply pressure against the interchangeable cover.

14. The method of claim 12, further comprising providing the at least one retention assembly configured to apply a pressure against an outer periphery of the interchangeable cover.

15. The method of claim 12, further comprising rotatably fastening the at least one retention assembly to a display housing.

16. The method of claim 12, further comprising inserting a swivel member into a base member, the swivel member configured to enable the base member to rotate relative to a display housing.

17. The method of claim 12, further comprising providing the interchangeable cover having a lip configured to prevent the at least one retention assembly from slipping outside the interchangeable cover.

18. An interchangeable cover assembly, comprising:
an interchangeable cover;
a display unit insertable into the interchangeable cover; and
a housing for the display unit having a plurality of retention assemblies configured to apply a balanced pressure to the interchangeable cover.

19. The interchangeable cover assembly of claim 18, wherein a fastener secures the each of the retention assemblies to a holding member extending from the back wall of the clock.

20. The interchangeable cover assembly of claim 18, wherein the each of the retention assemblies comprises at least one bend configured to deflect in a direction opposite to the balanced pressure applied to an outer periphery of the interchangeable cover.
